(19) United States
(12) Patent Application Publication
(10) Pub. No.: US 2005/0004839 A1
(43) Pub. Date: Jan. 6, 2005

(54) Method and system for providing incentives based on a payment type

(76) Inventors: Anton Bakker, Norfolk, VA (US); Marc L. Allen, Chesapeake, VA (US)

Correspondence Address: NIXON PEABODY, LLP, 401 9TH STREET, NW, SUITE 900, WASHINGTON, DC, 20004-2128, US

(21) Appl. No.: 10/840,615

(22) Filed: May 7, 2004

Related U.S. Application Data
(63) Continuation-in-part of application No. 10/137,375, filed on May 3, 2002.
(60) Provisional application No. 60/288,329, filed on May 4, 2001.
(60) Provisional application No. 60/468,646, filed on May 8, 2003.
(60) Provisional application No. 60/468,941, filed on May 9, 2003.

(51) Int. Cl. G06F 17/60

(52) U.S. Cl. 705/14; 705/16; 705/39

(57) ABSTRACT

A method and system for providing an incentive for a type of payment, including displaying a message on an information display device prompting for selection of a payment type having an associated incentive for a transaction; determining a total sale of the transaction from a point-of-sale device; computing a reward to be conveyed based on the total sale and the associated incentive, if the payment type having the associated incentive is selected; and dispensing the reward.

### CROSS-REFERENCE TO RELATED CASES

The present invention claims benefit of priority under 35 U.S.C. §119(e) to U.S. Provisional Patent Applications Ser. No. 60/468,646, filed May 8, 2003, entitled “Incentive Payment,” and No. 60/468,941, filed May 9, 2003, entitled “Incentive Payment,” and is a Continuation-in-Part application of commonly-assigned, co-pending, U.S. patent application Ser. No. 10/137,375, filed May 3, 2002, entitled “System and Methods for the Identification and Displaying of Information,” which claims benefit of U.S. Provisional Patent Applications Ser. No. 60/288,329, filed May 4, 2001, entitled “Customer Identifying Coupon Printer,” the entire disclosures of all of which are hereby incorporated by reference herein.

### BACKGROUND OF THE INVENTION

1. Field of the Invention

The present invention generally relates to methods and systems for providing incentives, and more particularly to a system and method for providing incentives based on use of a payment type.

2. Discussion of the Background

In recent years, multimedia devices are becoming more popular as, for example, mini advertising and information kiosks. They entertain and interact with customers, particularly those in a captive situation, such as waiting in line for groceries, purchasing tickets, or filling a gasoline tank at a service station.

Also, with the advent of computerized point of sale terminals, loyalty systems have been incorporated with point of sale terminals and loyalty systems in order to dispense a reward to customers for frequent use of a company's services, frequent purchasing of a company's goods, or the like. For example, frequent flyer miles are a prime example of how airlines reward passengers for traveling on their particular airline. The reward, based on the number of “miles” accumulated can vary from discounts on future airline ticket purchases, to seat upgrades, free tickets, or the like.

Likewise, grocery stores often implement a coupon-printing scheme whereby customers are given a coupon that is redeemable for future purchases after purchasing a particular product. For example, if a customer buys a particular brand of toothpaste, upon scanning of the toothpaste at the checkout counter, a printer associated with the cash register produces a coupon redeemable against the next purchase of a related mouthwash product. In this example, the triggering event for the printing of the coupon is the scanning, i.e., purchase, of a particular product. However, the generation of this coupon is independent of the identity and preferences of the user, or customer. For example, the user may not use mouthwash. Therefore, the printing of that particular coupon did not accomplish its intended purpose, the sale of another related product.

In addition to the above-mentioned loyalty systems, customer loyalty has been created by cash-back or points reward programs designed by credit or charge card issuers to encourage card holders to use their credit or charge cards (hereafter credit cards) to pay for purchases. If a customer uses a credit card with such a reward program, he/she may typically earn from 1% to 1.5% of the total amount spent, or he/she may earn a number of points based on the amount of money spent. The reward is usually given at the end of each credit or charge card billing cycle. If the reward is monetary, the amount of money earned as a reward is subtracted from the total card balance. If the reward is points-based, the points are accrued until there are enough to trade the bonus points for a gift.

While these types of incentive are usually of benefit to card users, they are generally not beneficial to retailers accepting credit card payments. This is generally due to the increased costs realized by merchants in the back-end processing required for credit card transactions. In order to provide the convenience and security of cashless payments to customers, retailers commonly provide options for paying with credit cards at no additional mark-ups to the merchandise sold. That is, whether payment is received in the form of cash or credit card, the prices of the same merchandises being sold are the same. The benefits of convenience and security for customers, however, are customarily provided by retailers who bear the expense of between 2% to 4.5% or more per purchase transaction which is charged by credit card companies to process credit card payments.

In view of the above, there is a need for a system and method for incentivizing customers to pay with cash which would create a win-win result for both the customers as well as retailers who can reduce their overheads by reducing usage fees paid to credit card companies.

### SUMMARY OF THE INVENTION

The present invention addresses the aforementioned and other needs by providing a system and method for providing an incentive for a purchase. More specifically, the present invention provides customers with choices involving selecting cash payment or credit card payment and dispensing a reward or disincentive based on the customers' selection. An exemplary embodiment of this invention, advantageously, can be used, for example, in conjunction with a loyalty system to provide information, such as coupons, to a user, such as a customer, based on their loyalty, purchasing habits, personal preferences, or the like. Instead of a cash reward for cash payment, coupons can be provided for discounted future purchases or for free redemption of merchandise.

Accordingly, in an exemplary aspect of the present invention there is provided a method and system for providing an incentive for a type of payment, including displaying a message on an information display device prompting for selection of a payment type having an associated incentive for a transaction; determining a total sale of the transaction from a point-of-sale device; computing a reward to be conveyed based on the total sale and the associated incentive, if the payment type having the associated incentive is selected; and dispensing the reward.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a functional block diagram illustrating an exemplary embodiment of the information display system according to this invention;

FIG. 2 is a flowchart illustrating an exemplary method of displaying information according to this invention;

FIG. 3 is a flowchart illustrating an exemplary method of selecting information according to this invention;

FIG. 4 is a flowchart illustrating an exemplary method of managing an account according to an exemplary embodiment of this invention;

FIG. 5 is a functional block diagram illustrating an exemplary embodiment of the information display device used in providing incentive for cash payment of the present invention;

FIG. 6 is a flowchart illustrating an exemplary method providing an incentive to make a cash payment for a purchase transaction using the system of FIG. 5;

FIG. 7 is a functional block diagram illustrating another exemplary embodiment of the information display device used in providing incentive for cash payment of the present invention; and

FIG. 8 is a flowchart illustrating an exemplary method for providing an incentive for making a cash payment for a purchase transaction using the system of FIG. 7.

### DETAILED DESCRIPTION OF THE PREFERRED EMBODIMENTS

The exemplary embodiments will be described in relation to methods and systems for providing incentives, and more particularly to a system and method for providing incentives based on use of a payment type. However, to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated however that the present invention may be practiced in a variety of ways beyond the specific details set forth herein. For example, the systems and methods of this invention can be scaled to any level and are capable of working in conjunction with various types of customer and already existing systems.

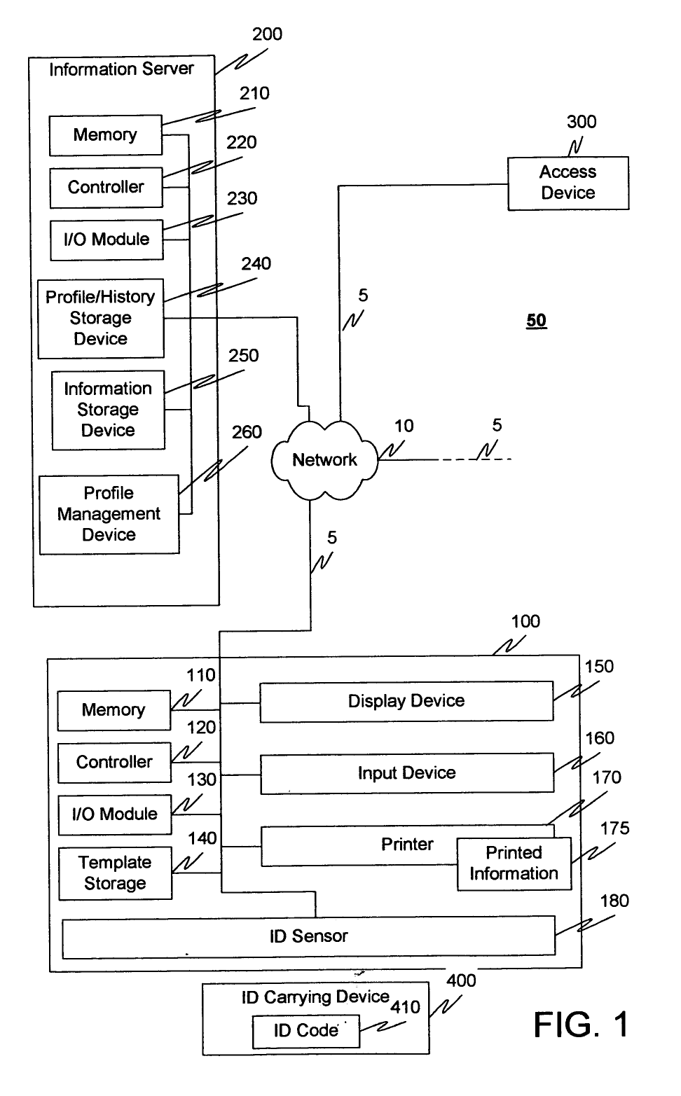

Referring now to the drawings, wherein like reference numerals designate identical or corresponding parts throughout the several views and more particularly to FIG. 1 thereof, there are illustrated an exemplary information display system 50. In FIG. 1, the exemplary information display system 50 comprises an information display device 100, an information server 200, and an access device 300, for example, interconnected by a network 10 and one or more links 5. The information display device 100 comprises a memory 110, a controller 120, an I/O module 130, a template storage 140, a display device 150, an input device 160, a printer 170 that outputs printed information 175, and an identification sensor (ID sensor) 180. The information display device 100 further communicates with an identification-carrying device 400 that stores one or more identification codes 410.

The information server 200 comprises a memory 210, a controller 220, an I/O module 230, a profile and history storage device 240, an information storage device 250 and a profile management device 260.

Using the system of FIG. 1, an individual can identify themselves to an information display device, such as a coupon printer, using, for example, an identification-carrying device that contains a unique identification code. The identification code is associated with a particular profile that identifies, for example, customer loyalty, preference and history data that may be associated with a particular user. An identification sensor senses the identification code on the identification-carrying device. The identification code is then forwarded via, for example, a local information display device, to an information server. The information server uses the identification code, and possibly additional information such as an identification of the information display device, to access loyalty and preference data associated with the identification code. This information can include, for example, coupons that have been issued to the user associated with the identification code, a user's preferences, a user's purchase history, or the like.

Based on one or more of the above, the information server determines and forwards information, such as coupon information, back to the information display device which can then, for example, print the coupon for the user. The information can be, for example, anything from coupon parameters used to create a coupon to a fully formatted coupon ready for immediate printing. For example, the information display device, which can include a coupon printer, may be separate from any other form of customer interaction, such as point-of-purchase terminals, gasoline dispensers, ATM's, or the like. Thus, while the information can be associated with a particular user interaction, the information can, for example, also be independent of any transactions that may have occurred at the same location.

While the exemplary embodiments illustrated herein show the various components of the information display system collocated, it is to be appreciated that the various components of the information display system can be located at distant portions of a distributed network, such as a local area network, a wide area network, a telecommunications network, an intranet and/or the Internet, or within a dedicated information display system. Thus, it should be appreciated that the components of the information display system can be combined into one or more devices or collocated on a particular node of a distributed network, such as a communications network. As will be appreciated from the following description, and for reasons of computational efficiency, the components of the information display system can be arranged at any location within a distributed network without affecting the operation of the system.

Furthermore, it should be appreciated that the various links connecting the elements can be wired or wireless links, or any combination thereof, or any other know or later developed element(s) that is capable of supplying and/or communicating data to and from the connected elements. Additionally, the term module as used herein, denotes any piece of hardware, software, or combination thereof is capable of performing the functions associated with that element.

In operation, the identification-carrying device 400 is placed within the sensible area of the identification sensor 180. Upon the identification sensor 180 sensing one or more identification codes stored within the identification-carrying device 400, the information display device 100 forwards the one or more identifications, as well as any other relevant information, to the information server 200. The information server 200 determines, for example based on the one or more identifications and, for example, an identification of the information display device 100, the information, if any, to be returned to the information display device 100 for display. Upon having made the determination, the information server 200 forwards to the information display device 100 all, a portion, or an identifier of information to be displayed on the information display device 100. The information display device 100 then displays the information, for example on the display device 150 and/or the prints the information 175 on the printer 170.

The identification-carrying device 400 can be any device that is capable of communicating with the identification sensor 180 in order to transfer information, such as the one or more identification codes 410, to the identification sensor 180. For example, the identification-carrying device 400 can communicate with the identification sensor 180 via a direct contact system, such as a magnetic strip and the identification sensor 180 a magnetic strip reader, an optical communication system, a radio frequency communication system or any other known or later developed electrical, inductive or capacitive based system that is capable of communicating the identification code to the identification sensor 180.

For example, the identification-carrying device 400 can be based on RFID (radio frequency identification) which typically operates in the frequency range of 60 KHz to 5.8 GHz. Common identification-carrying devices 400 operate at 900 KHz, 125 KHz, 13.56 MHz and 2.4 GHz. Examples of direct contact systems include the smartcard technology and magnetic strip readers. Optical systems can include, for example, barcode readers. Additionally, the identification-carrying device 400 can be integrated into a portion of a larger device, such as a wand or tag connected to a key chain. Examples of these devices are the Texas Instruments™. RFID tags, called “TIRIS”, the Phillips™. RFID tags, called “Mifair”, OTI RFID tags, Dallas Semiconductor's™ I-Button, or the like. Examples of smartcards, such as those produced by Schlumberger can also be used.

Alternatively, the identification-carrying device 400 can be a device that is capable of being written to as well as read from. For example, while the exemplary embodiments discussed below illustrate an embodiment where the user profile is stored on the information server 200, it is to be appreciated that it is also possible to store one or more portions of a user's profile on the identification-carrying device, or on a combination of the information server 200 and the identification-carrying device 400.

Upon the identification-carrying device 400 being placed in the sensible area of the identification sensor 180, the identification code 410 is read from the identification-carrying device 400 and forwarded, with the cooperation of the I/O module 130, the controller 120 and the memory 110, via network 10 and links 5, to the information server 200. Furthermore, the information display device 100 can supplement the identification code 410 code with additional information, such as the identifier of the information display device 100, the local time, whether any goods and/or services were purchased, an identification of those goods/services, local weather information, or in general any information that may be useful in terms of determining the information, if any, to be returned to the information display system 100. For example, if it is raining a coupon for a car wash is probably not appropriate.

Upon the information server 200 receiving the identification code and one or more additional portions of information, the information server 200 determines, with the cooperation of the memory 210, the controller 220, the I/O module 230 and the profile storage device 240, the type of information, if any, to be returned to the information display device 100. For example, the profile storage device 400 can make the determination based on the current transaction, a history of transactions associated with the particular identification code, a reward based system such as the “frequent flyer miles” program, a promotion based on a customer loyalty program, or the like.

Upon determining the type of information to be forwarded to the information display device 100, the profile storage device 240 cooperates with the information storage device 250, as well as the memory 210, the controller 220 and the I/O module 230, to retrieve and forward the selected information to the information display device 100. For example, the information storage device 250 can contain information, such as printable coupons, multi-media presentations, an identification and populatable portions of a template, audio and/or video clips, or the like, which is forwarded for subsequent display and/or printing at the information display device 100. Alternatively, the profile storage device 240 can forward an identifier to the information display device 100. This identifier corresponds to one or more types of information stored on the information display device 100 that can be displayed to, for example, a user.

Upon receipt of the information, or an identification of the information to be displayed, the information is displayed at the information display device 100 in cooperation with the memory 110, the controller 120 the I/O module 130, and if appropriate, the template storage 140. For example, based on the type of information, the information display device 100 determines one or more appropriate devices for displaying the information. For example, multimedia information can be displayed on the display device 150. Alternatively, information such as coupons can be displayed on the display device and printed via the printer 170.

In addition to being able to display information, the information display device 100 can allow a user to interact with one or more of the information display device 100 and the information server 200 via the input device 160. While the input device 160 is shown as a separate component, it is to be appreciated that, for example, the display device 150 and the input device 160 can be combined into one element, such as a touch screen. Alternatively, the input device 160 can be independent buttons such as, a “yes” and “no” buttons, or the like. Additionally, the input device can be speech activated and based on, for example, speech recognition and a voice driven menu and selection system.

Therefore, there are at least three modes of operation for the information display device 100. In a first mode, information is directly printed via the printer 170. In a second mode, and for example in conjunction with the display device 150, the user is prompted as to whether they would like to receive a print-out of selected information. For example, a preview of the information available to the user can be shown on the display device 150. If the user decides to receive a print-out of the information, the user selects, via a print button on input device 160, to print the information. Alternatively, the user can opt not to receive a print-out of the information and perhaps just view it on the display device 150. Thirdly, and again in conjunction with the display device 150 and the input device 160, the user can optional navigate through a variety of types of information that are available. If a printable version of the information is desired, the user can select, via the input device 160, to print that information. For example, if the information available to a user includes a coupon for a sandwich, a coupon for a car wash and coupon for a free gallon of gasoline, the user can select the coupon most appropriate for their needs.

The template storage device 140 is capable of storing one or more templates that can be used in association with the information server 200 for displaying information on one or more of the display device 150 and the printer 170. For example, the template storage 140 can store basic populatable coupon templates. Thus, the information server 200 can forward to the information display device 100 the information to be inserted into these templates. Then, with the cooperation of the controller 120 and the memory 110, the information from the information server 200 is merged with one or more templates in the template storage 140 and displayed. The templates can include printer templates, audio templates, video templates and/or multimedia templates.

Aside from the functionality associated with the user obtaining specific information associated with a particular identification code, the systems and methods of this invention also allow a user to create, manage and/or update their user profile, via, for example, access device 300. In particular, a user's profile is stored in the profile storage device 240. In general, the profile storage device 240 can contain any information about a user based on, for example, their associated identification code. For example, the profile storage device 140 can maintain an account of loyalty and/or rewards programs, user preferences, history logs, or any other information specific to a user.

A user accesses their profile with the access device 300. The access device 300 can be, for example, a computer, a PDA, a telephone, or the like. Alternatively, the access device 300 can be incorporated into the information display device 100. In general, the access device 300 allows a user to access, manage and manipulate one or more profiles stored in the profile storage device 240.

For example, and with the cooperation of the access device 300, a user enters their identification code, and, for example, a password. Upon authentication of the password, and in cooperation with the profile management device 260, the user is allowed to access portions of their profile. For example, the user can change their personal preferences regarding how they would like information to be displayed on the information display device 100. For example, a user can select that they always want have all available coupons printed, be queried whether they would like available coupons printed, to only show coupons for certain categories of goods, or the like. Furthermore, a user can access their profile to determine, for example, the number of points in a loyalty rewards program.

| Display | Printing | Advertising | History | Status |
|---|---|---|---|---|
| Preferences | Preferences | Preferences | Preferences | Preferences |
| Query Before | Print All Coupons | Show No | Remember All | Show Current |
| Displaying | | Advertising | Transactions | Rewards |
| | | | | “Points” |
| Display All | Print All Coupons | Show Advertising | Remember No | Do Not Show |
| Information | For X | For X | Transactions | Status |
| Only Show | Query Before | Only Show | Only Remember | Alert When |
| Multimedia | Printing | Advertising For | Transaction If | Award |
| | | Local Merchant(s) | Associated With | Threshold |
| | | | A Rewards | Reached |
| | | | Program | |
| Only Show | Print Coupon | | Forward Rewards | |
| Information | Only If Similar | | History at | |
| About X | Coupon | | Predetermined | |
| | Previously | | Interval to | |
| | Redeemed | | Destination | |
| Show News | Only Print | | | |
| Feed | Coupons That Are | | | |
| | Instantly | | | |
| | Redeemable | | | |
| Show Weather | Only Print | | | |
| Feed | Coupons That Are | | | |
| | Instantly | | | |
| | Redeemable For | | | |
| | Purchased | | | |
| | Product | | | |

A user can also review a history of, for example, the coupons they have printed, the information they have viewed, and print reports detailing these transactions.

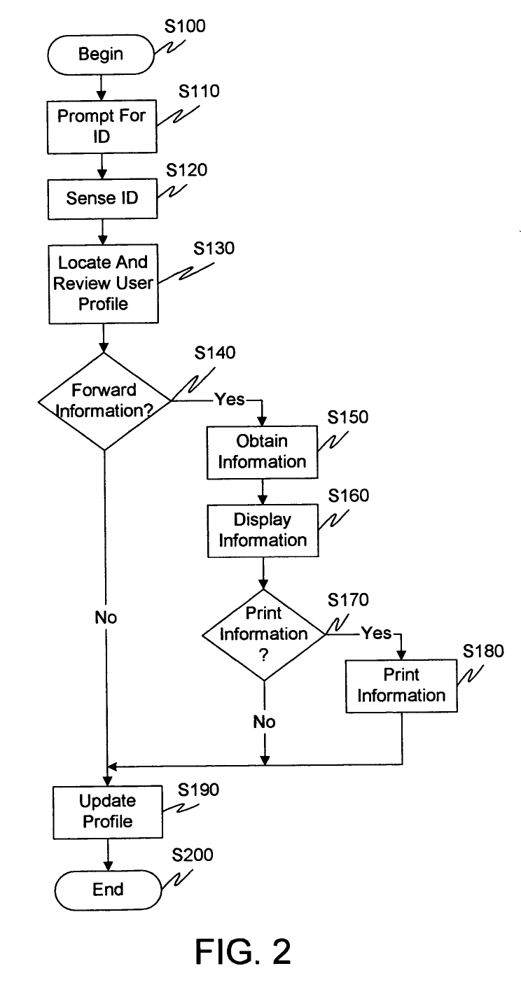

FIG. 2 outlines the exemplary operation of the information display system. In particular, control begins in step S100 and continues to step S110. In step S110, a user can optionally be prompted to place their identification-carrying device in the sensible area of the identification sensor. For example, the prompting can be based on an audio or video cue that could, for example, be triggered upon a user being within a certain proximity to an information display device. Next, in step S120, the identification code is sensed and retrieved from the identification-carrying device. Then, in step S130, the user profile, based on the sensed identification code is located and reviewed. Control then continues to step S140.

In step S140, a determination is made as to whether information should be forwarded to the user. For example, if the user profile specifies that the user would like to maintain a record of purchases for a rewards type system, but not receive any coupons or printed information, control would jump directly to step S190. If information is to be forwarded to the user, control continues to step S150.

In step S150, the appropriate information, or an identification of the information to be displayed, is obtained. For example, as discussed above, the determination of the information to be displayed can be dynamically determined based one or more portions of information. Next, in step S160, the information is displayed. Then, in step S170, a determination is made whether all or a portion of the information should be printed. For example, as discussed earlier, the determination can be based on query to the user or, for example, based a user's profile, or the like. If the information is to be printed, control continues to step S180 where the information is printed. Alternatively, the information can be printed or forwarded to one or more alternative or additional locations. For example, the user can specify in their profile that only coupons that are instantly redeemable should be forwarded to the printer. Other information or coupons that, for example, are not instantly redeemable, could be forwarded via mail, electronic and/or hard copy, to a destination specified in the user's profile. Control then continues to step S190.

Alternatively, if there is no desire to print the information, control jumps to step S190. In step S190, the user's profile is optionally updated. For example, as discussed previously, a user's history can be updated so as to, for example, log customers loyalty points, record a user's transactions, or the like. Control then continues to step S200 where the control sequence ends.

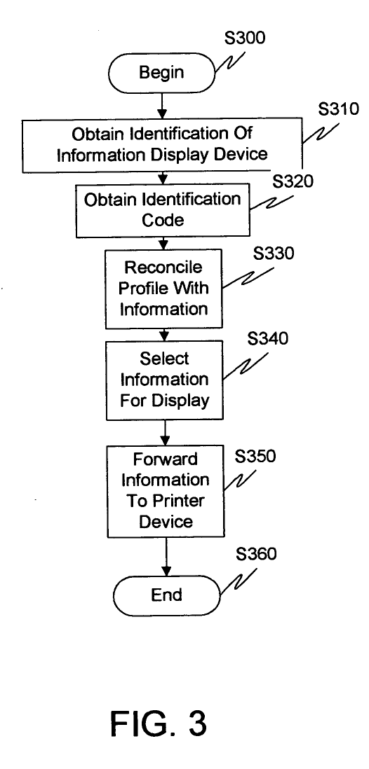

FIG. 3 outlines an exemplary method of selecting information according to this invention. In particular, control begins in step S300 and continues to step S310. In step S310, the identification code of the information display device can be optional obtained. For example, as discussed previously, in conjunction with the identification code of a user, the identification code for the information display device can also be used to aid in selecting the type of information to be presented to a user. Next, in step S320, the identification code is obtained.

In step S330, one or more of the information display device identification code and the identification code is reconciled with a user's profile information. Based on this reconciliation, in step S340, information is selected for display. Control then continues to step S350.

In step S350, the selected information is forwarded to the information display to be viewed, printed, or the like, by the user. Control then continues to step S360 where the control sequence ends.

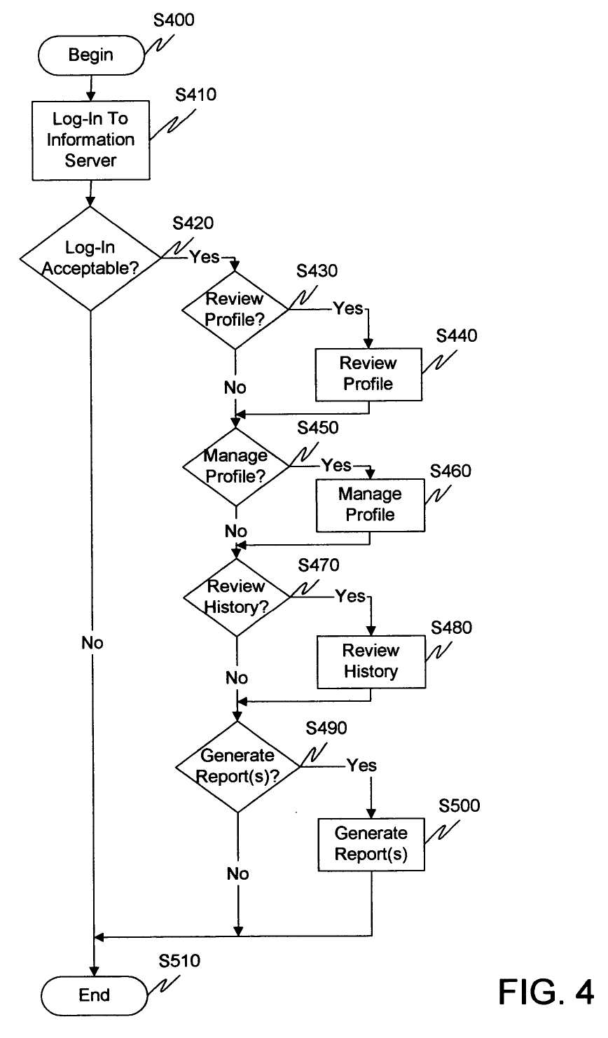

FIG. 4 outlines an exemplary method of accessing and managing a profile associated with an identification code according to an exemplary embodiment of this invention. In particular, control begins in step S400 and continues to step S410. In step S410 a user logs on to the information server. Next, in step S420, a determination is made as to whether the login was acceptable. If the login was acceptable, control continues to step S430. Otherwise, control jumps to step S510 where the control sequence ends.

In step S430, a determination is made as to whether the user would like to review their profile. If the user would like to review their profile, control continues to step S440 where a portion of the profile can be reviewed. Otherwise, control jumps to step S450. In step S450, a determination is made as to whether the user would like to manage their profile. If the user would like to manage their profile, control continues to step S460 where the used can modify/update a profile. Otherwise, control jumps to step S470.

In step S470, a determination is made as to whether the user would like to review their history. If the user would like to review their history, control continues to step S480 where the history can be reviewed, printed, or the like. Otherwise, control jumps to step S490.

In step S490, a determination is made as to whether the user would like to generate one or more reports. If the user would like to generate one or more reports, control continues to step S500 where the reports are generated. Otherwise, control jumps to step S510 where the controls sequence ends.

A typical loyalty system that could incorporate the above-described systems and methods of this invention could possible have other identification device readers associated with cash registers and gasoline dispensers, or the like, that are capable of accumulating loyalty and/or purchasing information that could also be assimilated with the systems and methods of this invention. For example, upon a user filling their car with fuel, the fuel pump loyalty system, cooperating with the systems and methods of this invention, could determine whether the user would desire a coupon for a car wash. Upon the systems and methods of this invention determining that the user received a coupon for a car wash yesterday that was redeemed, the system can determine if another type of coupon would be more appropriate, or determine that no coupon is necessary at this time. Alternatively, the system could query the user before the printing of the coupon to ensure that the coupon is desired.

For example, with the systems and methods of this invention, the user, such as a convenience store customer, is not necessarily required to accept any information, such as coupons, that they may be eligible for simple because they identify themselves to the information display system. Instead, the customer is allowed to obtain the information that they desire at a time when they desire through one or more of preferences and an input device that can obtain feedback from the user.

This allows, for example, added versatility in terms of how and what types of information can be provided. Specifically, a coupon need not be printed at the location it is earned. Thus, for example, by having the loyalty, preference and purchasing data held at a central location, loyalty preferences can be tracked at any location. For example, coupon printing can occur across many sites, such as in a chain of convenience stores. Many of the current loyalty systems either require the coupons to be printed at the moment they are earned or are created and maintained by an overall brand. Thus, these brand-based systems are location and brand specific.

In contrast, and in accordance with another exemplary advantage of this invention, the information display system can operate across a plurality of locations, for example, owned by a plurality of different entities, regardless of the brand association, or type of product and/or service sold.

The basic concepts associated with this invention can be expanded to be incorporated into identification sensing devices already present. For example, already existing identification sensors could forward and communicate with the information server according to the principles of this invention to allow a local printer or display device associated with the identification sensing device to print and/or display information, such as a coupon. For instance, a retail store's electronic cash register that supports RFID (Radio Frequency IDentification) may, for example, after having identified the customer, prompt the customer if they would like any available coupons, or a selected group of coupons, printed on the associated printer. Alternatively, the information, such as coupons, need not be physically printed, but an electronic version of the information, such as a coupon, can be forwarded and reconciled with, for example, an existing payment system.

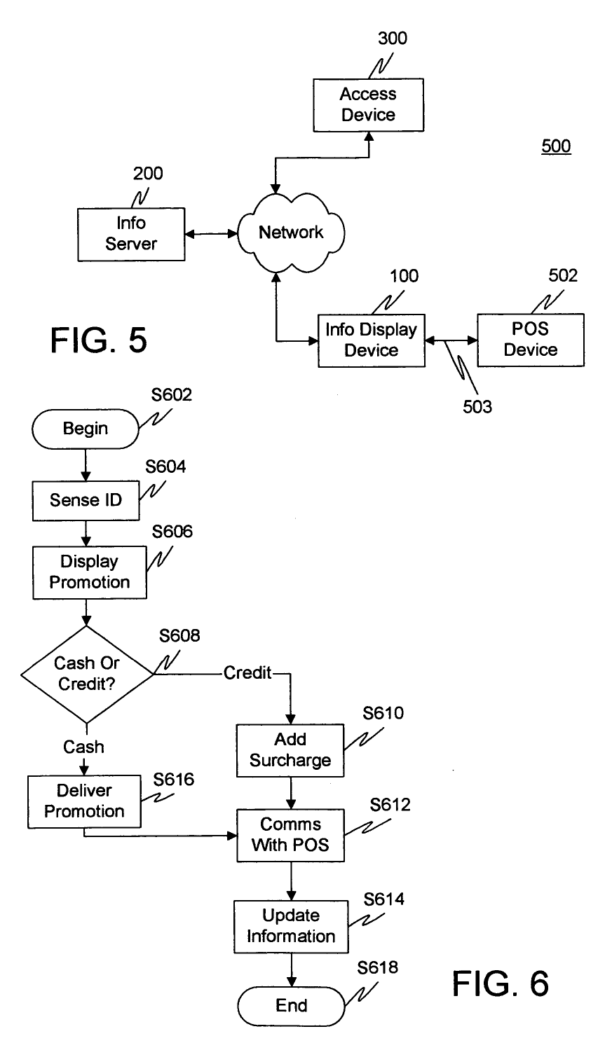

FIG. 5 illustrates a further exemplary embodiment of the present invention. The exemplary system of the embodiment illustrated in FIG. 5 includes information server 200, network 10, access device 300, and information display device 100 shown FIG. 1 and discussed above. For the sake of clarity FIG. 5 does not show the identification-carrying device 400. Further, for the sake of brevity and clarity, the similar features shared by both embodiments illustrated in FIGS. 1 and 5 are shown with same numerical labels, and their descriptions are not repeated hereafter.

FIG. 5, in addition to including all the features of FIG. 1, also includes POS 502 interfacing with the information display device 100. During a transaction in which the total amount of sale is needed to determine a discount or surcharge to be given or added, the information display device can query or monitor the POS device 502 to obtain the sales data.

FIG. 6 illustrates an exemplary process of providing an incentive to customers to make a payment with cash using the system illustrated in FIG. 5. In particularly, the process begins in step S602 and continues to step S604. In step S604, a customer can optionally be prompted to place their identification device in the sensible area of the identification sensor. For example, the prompting can be based on an audio or video cue that could, for example be triggered upon a customer being with a certain proximity to an information display device. Naturally, following the optional sensing of the customer's identification, the customer-specific information is retrieved from the identification-carrying device or from the profile/history storage 240 in the information server 200. Then, the user profile associated with the sensed identification code is optionally reviewed. The process then continues to step S606.

In step S606, a promotion directed to encouraging the customer to pay with cash for the pending transaction is presented. The promotion can be in the form of an audio message, or a graphic presentation, or a combination thereof. This step of presenting the promotion can be omitted if the customer's retrieved history shows a preference for cash payment for all purchases transactions where a discount is offered for cash payment. However, since there is a probability that the customer may not have any cash available, a confirmation of the customer's preference can be preferred.

Once a selection is made by a customer, exemplary courses of action can be taken, as shown in step S608. If cash payment is selected, the process continues to step S616 where a reward is delivered. The reward can be in a number of forms, such as an instant cash discount for the pending transaction, coupon for cash redemption, discount coupon for services, such as car washing, automobile inspection, automobile repair and maintenance, etc., free or discounted merchandises, such as foods, drinks, gas, videos, music, and etc. Coupons or redeemable rewards can be printed using printer 170 associated with the information display device 100 in FIG. 1.

In the case where instant cash discount is based on the total amount of goods or services purchased, the total amount reflected on the point-of-sale terminal is used in computing the discount to be rewarded. In order to obtain the total amount from the point-of-sale terminal, a means for the information display device to receive the total amount can be provided, such as shown in link 503 between information display 100 and POS device 502 in FIG. 5. This link may be a direct wired or wireless link between the two electronic devices, or it may be an indirect link via an operator monitoring the transaction being made. The cash discount can be added to the total purchase by passing the discount information to the POS device directly or indirectly through the intervention of an operator overseeing the purchase transaction, as shown in step S612.

In the case where credit payment is selected by the customer in step S608, a surcharge can be optionally added in step S610, and the surcharge amount is passed to the POS device directly or indirectly through the intervention of an operator overseeing the purchase transaction, as shown in step S612. Although FIG. 6 illustrates both the addition of a surcharge in case of a credit card payment and the delivery of a reward or promotion for cash payment, the process should be understood as also having the flexibility to select either a method for providing an incentive for cash payment or a method for providing a disincentive for credit card payment or other payment types.

If the customer has an identification code and is detected by the information display device, past purchase history and personal profile and preferences, for example, can be used to dynamically determine the amount of discount given, the amount of surcharge to be added, or actions to be taken as an encouragement to pay cash or as a discouragement from paying by credit card.

In addition to taking the aforementioned factors into consideration in determining a reward or surcharge, the time of purchase, the item purchased and manufacturer incentives can also be accounted for in determining a reward or surcharge. Time-related discounts or incentives can be used to motivate and attract customers to frequent the retailer during off-peak hours or during business day where business is customarily not busy.

In step S614, the action taken in step S610 or the step taken in S616 can be reported to information server 200 so that customer's selection and purchase habits or history can be recorded for future reference, if customer's identification was sensed at the beginning of the transaction. Further, the promotion delivered in step S616 can also be recorded for inventory purposes, even if no customer identification was sensed and the transaction is not associated with the customer. For example, if the reward is a coupon for a soft drink, upon redemption information on the coupon can be scanned for verification and inventory can be updated automatically. As another example, if the reward was cash discount, a receipt journal (not shown) can be updated automatically. Finally, the process ends in step S618 where the purchase transaction is completed.

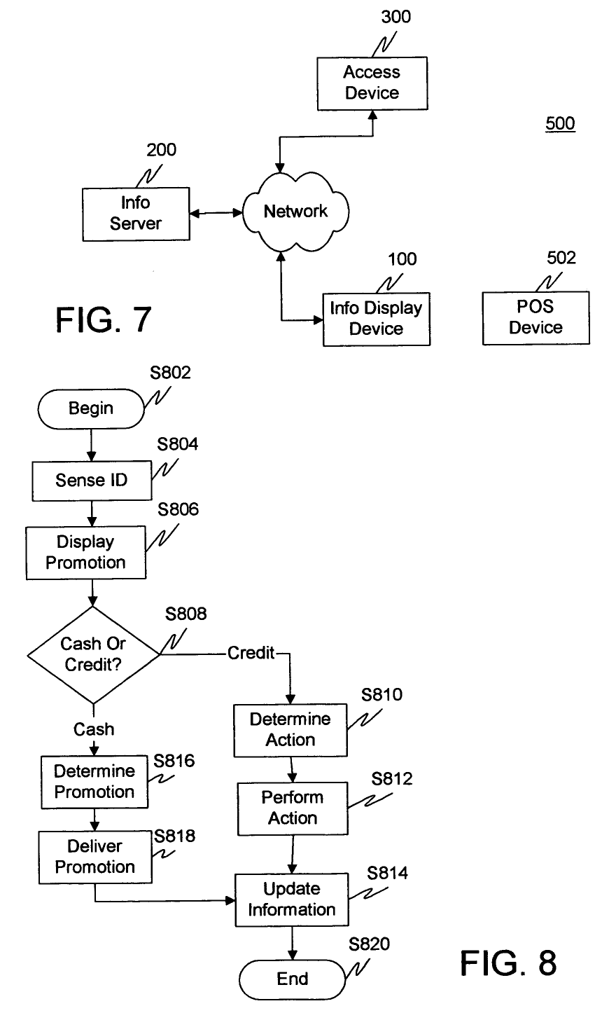

The above-described exemplary system of the present invention notably includes the communication between the POS device 502 and the information display device 100. This communication, via a direct electronic interface or an indirect intervention of an operator, allows the total price to be paid by the customer to display on the POS device which instantly reflects any cash discounted rewarded or any surcharged added. However, in the case where information flow between a POS device 502 and a information display device 100 is not desirable to simplify the integration and installation of the information display device 100 and its associated networking components, there is preferably no direct or indirect interface between POS device 502 and the information display device 100, such as shown in FIG. 7.

FIG. 8 illustrates an exemplary process utilizing the system in FIG. 7 for providing an incentive to customers to make a payment with cash. In particularly, the process begins in step S802 and continues to step S804. In step S804, a customer can optionally be prompted to place their identification device in the sensible area of the identification sensor. For example, the prompting can be based on an audio or video cue that could, for example be triggered upon a customer being with a certain proximity to an information display device. Naturally, following the optional sensing of the customer's identification, the customer-specific information is retrieved from the identification-carrying device or from the profile/history storage 240 in the information server 200. Then, the user profile associated with the sensed identification code is optionally reviewed. The process then continues to step S806.

In step S806, a promotion directed to encouraging the customer to pay with cash for the pending transaction is presented. The promotion may be in the form of an audio message, or a graphic presentation, or a combination thereof. This step of presenting the promotion may be omitted if the customer's retrieved history shows a preference for cash payment for all purchases transactions where a discount is offered for cash payment. However, since there is a probability that the customer may not have any cash available, a confirmation of the customer's preference can be preferred.

Once a selection is made by a customer, exemplary courses of action can be taken, as shown in step S808. If cash payment is selected, the process continues to step S816 where a reward is delivered. The reward can be in a number of forms, such as an instant cash discount for the pending transaction, coupon for cash redemption, discount coupon for services, such as car washing, automobile inspection, automobile repair and maintenance, and free or discounted merchandises, such as foods, drinks, gas, videos, music, and etc. Coupons or redeemable rewards can be printed using printer 170 associated with the information display device 100 in FIG. 1.

In the case where instant cash discount is based on the total amount of goods or services purchased, the total amount reflected on the point-of-sale terminal can be used in computing the discount to be rewarded. However, unlike the process in FIG. 6, the means for the information display device to receive the total amount can be provided but without a link between the information display 100 and the POS device 502 as shown in FIG. 7. This link can be via, for example, an operator monitoring the transaction being made. The cash discount can be added to the total purchase, for example, by passing the discount information to the POS device through the intervention of an operator overseeing the purchase transaction.

If the customer has an identification code and is detected by the information display device, past purchase history and personal profile and preferences, for example, can be used to dynamically determine the amount or type of discount or reward given.

In addition to taking the aforementioned factors into consideration in determining a reward for cash payment, the time of purchase, the item purchased, weather condition, manufacturer incentives, or the like, can also be accounted for in determining a reward. Time-related discounts or incentives can be used to motivate and attract customers to frequent the retailer during off-peak hours or during business day where business is customarily not busy. Current weather condition can be used to target weather-related services or merchandises.

As previously mentioned, although the POS device's sales information can be utilized, an electronic link between information display device 100 and POS device is preferably omitted for an increase in simplicity in the installation of the system and for a decrease in hardware cost and maintenance. Hence, actions to be taken in response to customers' selection of cash or credit payment are tailored such that incentive for cash payment or disincentive for credit card payment can still be provided by the information display device 100 without entailing a connection to the POS device 502.

In the case where credit payment is selected by the customer in step S808, instead of adding a surcharge, as in step S610 of FIG. 6, an appropriate action is determined in step S810. Based on user profile and purchase history, if the identity of the customer was sensed, or based on other factors such as time, date, item being purchased, the weather condition, etc., a suitable action can be dynamically determined. For example, a message can be played by the information display device for the customer to further encourage the alternative cash payment in future transactions.

In step S814, the action taken in step S810 or the step taken in S816 can be reported to information server 200 so that customer's selection and purchase habits or history can be recorded for future reference, if customer's identification was sensed at the beginning of the transaction. Further, the promotion delivered in step S816 can also be recorded for inventory purposes, even if no customer identification was sensed and the transaction is not associated with the customer. For example, if the reward was cash discount, a receipt journal, not shown, can be updated automatically. Finally, the process ends in step S820 where the purchase transaction is completed.

Thus, the exemplary embodiments include employing a multimedia information display to offer customers an incentive to make a purchase with cash payment and to dispense a reward for paying with cash, determining how payment is made for a purchase transaction and rewarding customers based on the type of payment made based on at least one of loyalty program, user history, current transaction data, past transactions, and user profile, providing a cash discount through the use of an information display device if customers make a cash payment in lieu of a credit card payment, adding a surcharge to the total amount due if a purchase is paid with a credit card, communicating with a point-of-sale terminal to add a surcharge to the total sale of a transaction if cash payment is not selected, communicating with a point-of-sale terminal to discount the total sale of a transaction, or the like.

The present invention for selecting and displaying information and providing an incentive for making cash payment can be implemented in conjunction with an already existing customer loyalty type system, a point-of-purchase system, or a separate programmed general purpose computer having a communications device. The present method can also be implemented in a special purpose computer, a programmed microprocessor or a microcontroller and peripheral integrated circuit element(s), an ASIC or other integrated circuit, a digital signal processor, a hardwired or electronic logic circuit such as a discrete element circuit, a programmable logic device, such as a PLD, PLA, FPGA, PAL, or the like, and associated communications equipment.

Furthermore, the disclosed exemplary methods can be readily implemented in software using object or object-oriented software development environments that provide portable source code that can be used on a variety of computer, workstation or modem hardware and/or software platforms. Alternatively, the method may be implemented partially or fully in hardware using standard logic circuits or a VLSI design. Other software or hardware can be used to implement the methods in accordance with this invention depending on the speed and/or efficiency requirements of the system, the particular function, and the particular software and/or hardware or microprocessor or microcomputer(s) being utilized. Of course, the present method can also be readily implemented in hardware and/or software using any known later developed systems or structures, devices and/or software by those of ordinary skill in the applicable art from the functional description provided herein and with a general basic knowledge of the computer and telecommunications arts.

Moreover, the disclosed methods can be readily implemented as software executed on a programmed general purpose computer, a special purpose computer, a microprocessor and associated communications equipment, or the like. In these instances, the methods and systems of this invention can be implemented as a program embedded in an information display system, or the like. The methods can also be implemented by physically incorporating operational equivalents of the methods into software and/or hardware, such as a hardware and software system of an information display system, or the like.

While the present invention has been described in connection with a number of exemplary embodiments and implementations, the present invention is not so limited but rather covers various modifications and equivalent arrangements, which fall within the purview of the appended claims.

1. A method of providing an incentive for a type of payment, comprising:
displaying a message on an information display device prompting for selection of a payment type having an associated incentive for a transaction;
determining a total sale of the transaction from a point-of-sale device;
computing a reward to be conveyed based on the total sale and the associated incentive, if the payment type having the associated incentive is selected; and
dispensing the reward.

2. The method of claim 1, wherein the payment type having the associated incentive comprises a cash payment.

3. The method of claim 1, wherein a payment type not having an associated incentive comprises a credit card payment.

4. The method of claim 1, wherein the step of computing the reward comprises dynamically determining the reward based on at least one of a loyalty program, a user history, a current transaction, a past transaction, and a user profile.

5. The method of claim 2, further comprising:
computing a surcharge, if the cash payment is not selected; and
communicating with the point-of-sale terminal to add the surcharge to the total sale of the transaction.

6. The method of claim 1, wherein the step of dispensing the reward comprises communicating with the point-of-sale terminal to discount the total sale of the transaction.

7. A system for providing an incentive for a type of payment, comprising:
means adapted for displaying a message on an information display device prompting for selection of a payment type having an associated incentive for a transaction;
means adapted for determining a total sale of the transaction from a point-of-sale device;
means adapted for computing a reward to be conveyed based on the total sale and the associated incentive, if the payment type having the associated incentive is selected; and
means adapted for dispensing the reward.

8. The system of claim 7, wherein the payment type having the associated incentive comprises a cash payment.

9. The system of claim 7, wherein a payment type not having an associated incentive comprises a credit card payment.

10. The system of claim 7, wherein the means for computing the reward comprises means for dynamically determining the reward based on at least one of a loyalty program, a user history, a current transaction, a past transaction, and a user profile.

11. The system of claim 8, further comprising:
means adapted for computing a surcharge, if the cash payment is not selected; and
means adapted for communicating with the point-of-sale terminal to add the surcharge to the total sale of the transaction.

12. The system of claim 7, wherein the means adapted for dispensing the reward comprises means adapted for communicating with the point-of-sale terminal to discount the total sale of the transaction.

13. The system of claim 7, wherein the display means, the means for determining a total sale, means for computing a reward and means for dispensing the reward comprise devices of a computer system.

14. The system of claim 7, wherein the display means, the means for determining a total sale, means for computing a reward means and means for dispensing the reward comprise computer-readable instructions stored on a computer-readable medium.
